(19) United States
(12) Patent Application Publication
(10) Pub. No.: US 2007/0082614 A1
(43) Pub. Date: Apr. 12, 2007

(54) Personal security aware subscription service framework

(75) Inventor: Von A. Mock, Boynton Beach, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/247,485

(22) Filed: Oct. 11, 2005

(51) Int. Cl. H04Q 7/20

(52) U.S. Cl. 455/41.2; 455/456.2; 455/404.1

(57) ABSTRACT

A personal safety monitoring system (100) can include a safety monitoring device or vehicle monitoring device (120) operatively coupled to a first short range transceiver (122) for monitoring operational safety parameters of a vehicle (118). The system can further include a wireless communication device (101) such as a cellular phone that includes a wide area network wireless transceiver (102) for communication over a wide area network (114), a second short range transceiver (105) operatively coupled to the wide area network wireless transceiver, and a processor (114) coupled to the wide area network wireless transceiver and the second short range transceiver. The processor can be programmed to establish a communication link with the safety monitoring device using the second short range transceiver and communicate a signal using the wide area network wireless transceiver to a predetermined address if at least one predetermined threshold is exceeded by the safety monitoring device.

### FIELD OF THE INVENTION

This invention relates generally to safety monitoring systems, and more particularly to a method and system for using short and long range wireless communication services to monitor a user's safety.

### BACKGROUND OF THE INVENTION

A number of companies now offer assistance to parents to determine if their child is driving or has driven irresponsibly. There are a variety of devices on the market that track the actions of an intended target, but they generally fail to provide real time information or information substantially in real time to enable some corrective action based on the offending action being tracked. One example is a device that plugs into a vehicle's electrical / computer system and usually resides under the seat or chassis of the vehicle. At the low end of the offering, a parent can buy a black box device that allows recording of a vehicle's parameters. The black box can track such parameters as speed, sudden acceleration, sudden braking, and swerves. The black box can certainly inform the parent of poor driving behavior a period after the occurrence and provide somewhat of a deterrent if the child is actually driving, but such a device will not immediately notify the parent of the offensive behavior nor provide an opportunity to rectifying the offensive behavior.

### SUMMARY OF THE INVENTION

Embodiments in accordance with the present invention can enable a passenger or other occupants within a vehicle to subscribe to a service of a safe driver box or other safety monitoring device. The safe driver box can have a Bluetooth or other short range wireless connection enabling a comparable short range wireless equipped cell phone (or other longer range wireless device) to search out, discover and gain access to the information provided by the safe driver box. If a safety concern is detected, the safe driver box can inform the longer range wireless device and the longer range wireless device can inform a parent or other user concerned with the safety of the user of the longer range wireless device.

In a first embodiment of the present invention, a wireless communication device can include a first wireless transceiver for communication over a wide area network, a second wireless transceiver for communication over a short range, and a processor coupled to the first wireless transceiver and the second wireless transceiver. The processor can be programmed to establish a communication link with a vehicle monitoring device using the second wireless transceiver and communicate a signal using the first wireless transceiver to a predetermined address (such as a guardian's home phone number, cellular phone number, dispatch private identifier, short messaging address, or email address). The processor can be further programmed to communicate the signal using the first wireless transceiver the first predetermined address if at least one predetermined threshold is exceeded by the vehicle monitoring device. The first wireless transceiver can be a cellular wireless transceiver and the second wireless transceiver can be a Bluetooth transceiver. The vehicle monitoring device can monitor at least one or more parameters among speed, location, acceleration, breaking distance, and airbag deployment and the corresponding thresholds can be a speed limit, an acceleration, a deceleration, or an airbag deployment. In one aspect, the processor can be further programmed to safely disable a vehicle remotely by receiving signals from the first wireless transceiver and relaying them to the second wireless transceiver. The wireless communication device can also include a satellite position system receiver coupled to the processor. The second wireless transceiver can also use at least one among an Open Services Gateway framework, Simple Object Access Protocol, or Bluetooth to communicate over a short range with the vehicle monitoring device. The processor can also be programmed to determine the at least one predetermined threshold by receiving an external signal from a traffic authority and computing a threshold from the external signal.

In a second embodiment of the present invention, a personal safety monitoring system can include a safety monitoring device operatively coupled to a first short range transceiver for monitoring operational safety parameters of a vehicle, a wide area network wireless transceiver for communication over a wide area network, a second short range transceiver operatively coupled to the wide area network wireless transceiver, and a processor coupled to the wide area network wireless transceiver and the second short range transceiver. The processor can be programmed to establish a communication link with the safety monitoring device using the second short range transceiver and communicate a signal using the wide area network wireless transceiver to a predetermined address. The processor can be further programmed to communicate the signal using the wide area network wireless transceiver to the predetermined address if at least one predetermined threshold is exceeded by the safety monitoring device. The wide area network wireless transceiver can be a cellular wireless or a WLAN transceiver and the second wireless transceiver can be a Bluetooth transceiver for example. The safety monitoring device can monitor at least one or more parameters among speed, location, acceleration, breaking distance, or airbag deployment. Note the at least one predetermined threshold can be among a speed limit, an acceleration, a deceleration, or an airbag deployment where the predetermined threshold(s) can be pre-stored in the safety monitoring device or transmitted over the air to the safety monitoring device from the second short range transceiver to the first short range transceiver. The processor can be further programmed to determine the at least one predetermined threshold by receiving an external signal from a traffic authority and computing a threshold from the external signal.

In a third embodiment of the present invention, a method of monitoring personal safety of a third party in a vehicle, can include the steps of establishing a communication link between a wide area wireless transceiver and a short range wireless transceiver, monitoring a predetermined list of parameters and corresponding thresholds related to safe vehicle operation, reporting information regarding any excesses beyond the corresponding thresholds to the wide area wireless transceiver via the short range wireless transceiver, and relaying the information from the short range wireless transceiver to a predetermined address using the wide area wireless transceiver. Monitoring can involve monitoring at least one or more parameters among speed, location, acceleration, breaking distance, and airbag deployment. Relaying can involve relaying to a predetermined address among a guardian's home phone number, cellular phone number, dispatch private identifier, short messaging address, or email address. In one aspect, the method can further include the step of safely disabling a vehicle remotely by receiving signals from the first wide area wireless transceiver and relaying them to the short range wireless transceiver. The method can further include the step of determining the at least one predetermined threshold by receiving an external signal from a traffic authority and computing a threshold from the external signal.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a personal safety monitoring system including a wide area wireless link and a short range wireless link to a safety monitoring device in accordance with an embodiment of the present invention.

FIG. 2 is a software layer model for a family safety telematics application in accordance with an embodiment of the present invention.

FIG. 3 is a ladder diagram of a general process flow to gain access to a safety monitoring device in accordance with an embodiment of the present invention.

FIG. 4 is a flow chart illustrating a method of monitoring personal safety of a third party in a vehicle including the process of subscribing and initiating the monitoring process in accordance with an embodiment of the present invention.

FIG. 5 is a flow chart illustrating another method of monitoring personal safety of a third party in accordance with an embodiment of the present invention.

FIG. 6 is an individual profile containing threshold values that can be used in monitoring and creating alert messages in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

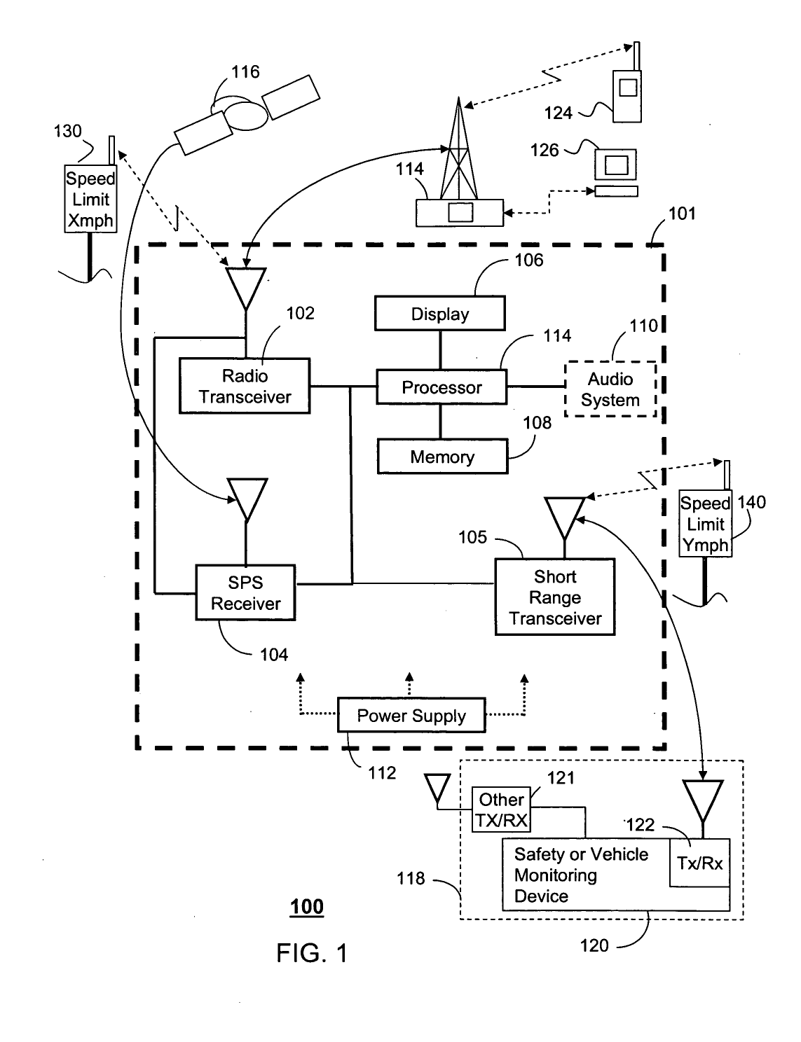

Referring to FIG. 1, a personal safety monitoring system 100 is shown including a safety monitoring device or vehicle monitoring device 120 operatively coupled to a first short range transceiver 122 for monitoring operational safety parameters of a vehicle 118. The system 100 can further include a wireless communication device 101 such as a cellular phone that includes a wide area network wireless transceiver 102 for communication over a wide area network 114, a second short range transceiver 105 operatively coupled to the wide area network wireless transceiver 102, and a processor 114 coupled to the wide area network wireless transceiver 102 and the second short range transceiver 105. The wide area network 114 can include one or more wireless base stations commonly found in cellular communication networks. The processor 114 can be programmed to establish a communication link with the safety monitoring device 120 using the second short range transceiver 122 and communicate a signal using the wide area network wireless transceiver 102 to a predetermined address. In one embodiment, the wide area network wireless transceiver used to communicate with the predetermined address can be part of the wireless device 101 (such as transceiver 102). In another embodiment, the wireless network transceiver can actually be part of or coupled to the safety monitoring device 120 such as transceiver 121. The processor can be further programmed to communicate the signal to the predetermined address if at least one predetermined threshold is exceeded by the safety monitoring device 120. The predetermined address can be a guardian's home phone number, cellular phone number such as a parent's cell phone 124, a dispatch private identifier, short messaging address, or an email address accessible from the a computer 126 communicatively linked to the wide area network 114. The wide area network wireless transceiver 102 can be a cellular wireless or a WLAN transceiver and the second wireless transceiver can be a Bluetooth transceiver.

The safety monitoring device 120 can monitor at least one or more parameters among speed, location, acceleration, breaking distance, or airbag deployment. Note the at least one predetermined threshold can be among a speed limit, an acceleration, a deceleration, or an airbag deployment where the predetermined threshold(s) can be pre-stored in the safety monitoring device 120 or transmitted over the air to the safety monitoring device from the second short range transceiver 105 to the first short range transceiver 122. The processor 114 can be further programmed to determine the at least one predetermined threshold by receiving an external signal from a traffic authority (130 or 140) and computing a threshold from the external signal. The traffic authority can be a traffic signal beacon transmitting a particular speed limit that can be fixed or adjusted based on weather or other environmental conditions.

As noted above, the wireless communication device 101 can be a cellular phone, but the device 101 can be other wireless communication devices such as personal digital assistants, laptop computers or other devices having the appropriate wireless capability. The wireless device 101 can further include an satellite positioning system (SPS) receiver 104 such as a GPS receiver in communication with one or more satellites 116 for providing location services. The wireless communication device 101 can further include a display 106 for conveying images to a user of the device, a memory 108 including one or more storage elements (e.g., Static Random Access Memory, Dynamic RAM, Read Only Memory, etc.), an optional audio system 110 for conveying audible signals (e.g., voice messages, music, etc.) to the user of the device, a conventional power supply 112 for powering the components of the device, and the processor 114 comprising one or more conventional microprocessors, microcontrollers, and/or digital signal processors (DSPs) for controlling operations of the foregoing components.

In one embodiment, a carrier of the wireless communication device 101 as a passenger or other occupant of a vehicle 118 (such as a car or taxi) can “subscribe” to the service of the safety monitoring device or safe driver box 120. The safe driver box 120 can be enabled with Bluetooth or other short range wireless communication that would allow a Bluetooth (or other wireless standard) equipped cell phone to search out, discover and gain access to the information provided by the safe driver box 120.

A parent, for example, can potentially program their child's mobile device to search out homeland security features. In so doing, the child's device can utilize the safe driver box service notifications that can be generated when certain thresholds are exceeded or other safety factors become a concern. Reports and other notifications from the safe driver box 120 can be transmitted to the parent (124) or other administrative person (126) via the wide area network 114 through the child's cell phone 101. The types of notifications that can be sent to the parent through the child's cell phone can include indications that the child has entered a particular person's car (friendly name maybe available that can be transmitted along with notification), that the child has exited the particular person's car (location information may also be provided at this time using location services using GPS, triangulation or other location techniques), that the driver of car is driving aggressively or dangerously (speeding, car is accelerating around a curve, etc). If the safety monitoring device 120 was enabled, there could also a way to safely disable the vehicle using the wide area network and known telematic techniques.

In the case of the parent receiving notification of a dangerous driver, the parent can provide information to local law enforcement so that the driver can be stopped and the child can be safely let out. Location information that is provided to the parent can be forwarded to the law enforcement.

In addition, a parent can allow the law enforcement individual to subscribe to the car's location information along with speed, direction and other parameters for a specific period of time to enable tracking of the car. There may also be times when a teen or other loved one is not allowed to ride in the same automobile as another person. In this case the automobile can be disabled, possibly using a remote signal to activate a kill switch.

The ever-growing presence of Bluetooth-enabled devices is evident in a number of market segments including mobile phones, telematics, cameras, printers and other accessories. This continued growth creates a ubiquitous environment that enables a mobile device to connect and utilize the services of the device. Motorola will likely enable an Open Services Gateway architecture within their mobile devices, which will allow for accessing or subscribing to available services. Embodiments herein can extend upon this concept by leveraging the (Simple Object Access Protocol) SOAP layer and Open Services Gateway framework to allow individuals to subscribe or access services that are available within their personal area network.

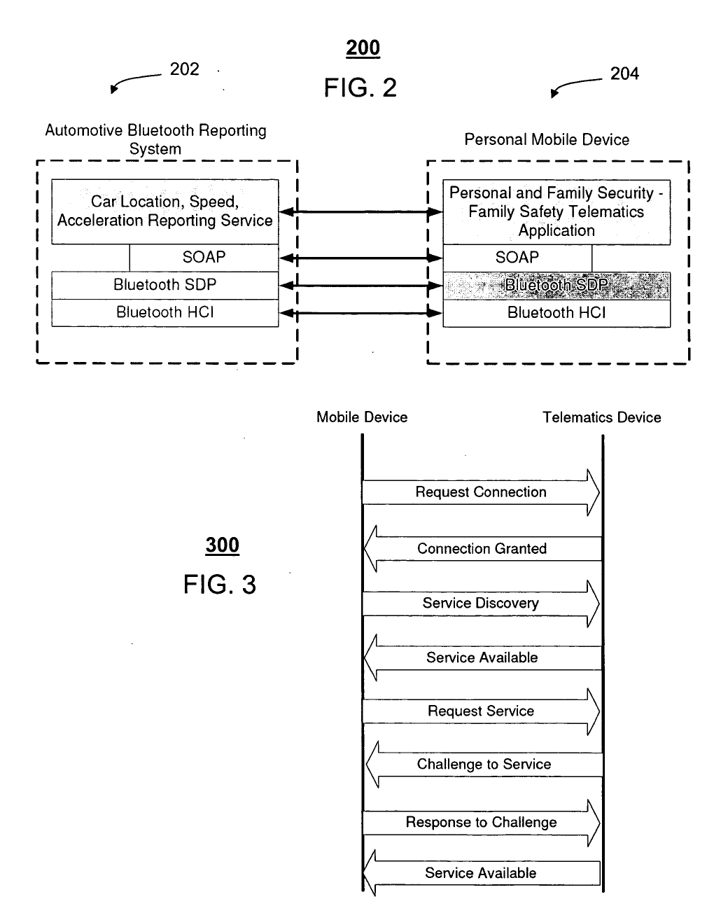

Referring to FIG. 2, a personal safety system 200 is illustrated including an automotive Bluetooth Reporting system or telematic device 202 and a personal mobile device 204 such as a cellular phone. The application layers for mobile device 204 and telematic device 202 are able to communicate through the SOAP layer as shown. Bluetooth can provide a networking SOAP layer that provides a networking protocol layer between applications to access services and capabilities. At a lower layer with the Bluetooth device, the Service Discovery Protocol portion identifies if a device supports SOAP and in turn notifies the SOAP layer. Of course, the devices can communicate using other protocols as well and are not limited to the ones shown.

The most basic implementation of a Bluetooth connection is a pairing process which allows a user to “pair” with an accessory such as a headset to use for voice communications or a printer to print images captured with the phone. The pairing process is initially done once with all future access more automatic. This pairing process works well when all the devices being connected to are “my” own personal devices, but in a broader view where connections may not only be to personal device, this invention may not be adequate. Bluetooth fortunately has provided additional capabilities at both a networking layer and a service discovery that will allow a mobile device to connect and utilize the service of another device. Such a rapid interaction is illustrated in the flow diagram 300 of FIG. 3 where a mobile device requests a connection, a telematic device grants the connection, a service discovery is made and a request for a particular service is made if the service is available. In one aspect such as a subscription scenario, the flow can continue by having the telematics device issue a challenge to service and the mobile device can respond before making the service available. Thus, a child's mobile device can utilize the telematics Bluetooth reporting device to notify a parent of in appropriate driving behavior whether the child is driving or is a passenger in the telematic equipped vehicle.

In another aspect of this invention, a business such as a Taxi company can utilize a driver advocate tracking device to provide an extended service to teens or children that employ a consumer homeland security client in their mobile device. The Taxi service picking up the teen can immediately enable the teen's mobile device by registering with the driver advocate-tracking device and inform the parent's or other loved ones of being in a particular Taxi. An additional service can allow for the mobile device to request that no un-trusted adult or teen may share the ride with the current teen. A person becomes trusted once they subscribe to the Taxi service and complete a profile that authenticates the user. Each subsequent request or entry into a taxi goes through a short challenge and response to authenticate the user as previously discussed with respect to FIG. 3.

During the subscribing or accessing of a service, verification can be made whether an object is trusted. One implementation would enable a user of the service to be notified that someone wants to gain access to the service and is given permission or is denied the service. In a more specific example, a child's potential driver can see a prompt on their mobile phone or telematics dashboard for a request to subscribe. The driver can give permission to allow for subscribing to the telematics service (speed, breaking, acceleration, etc.) or can deny. In this case of denial, a parent or guardian would receive an indication that the child has been denied service. Further inquiry from the parent or guardian can follow including calls to the child or the driver by the parent. Another implementation can use a trusted authority that provides a challenge and response to the request for service. Users can subscribe to a service and receive a certificate that is later used in the challenge and response mechanism.

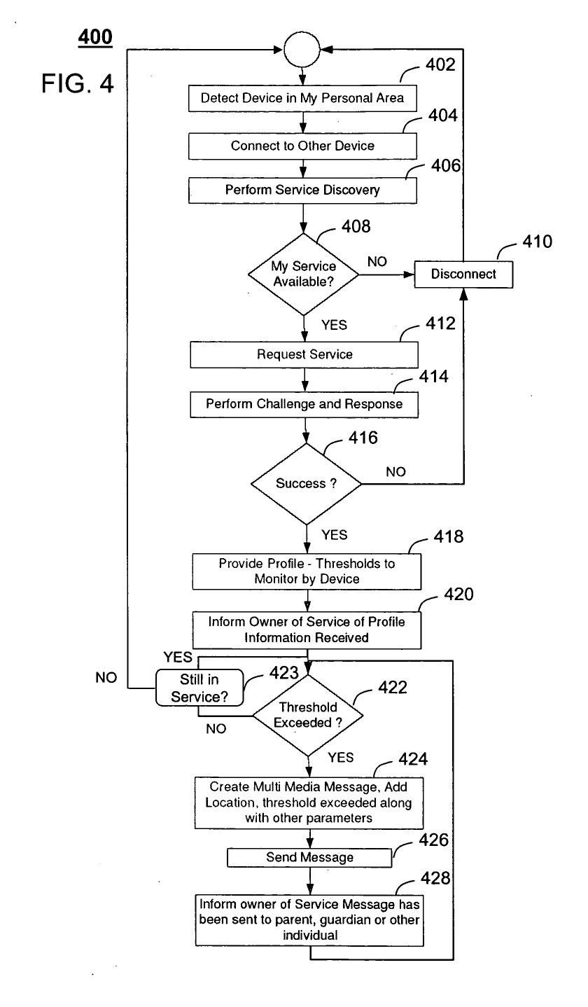

Referring to FIG. 4, a flow chart of a method 400 of monitoring personal safety of a third party in a vehicle and more particularly of a mobile device interaction with a telematics unit. The mobile device can detect a telematics device in their personal area at step 402 and connect to such device at step 404 and perform a service discovery at step 406. If no service is available at decision block 408, the devices disconnect at step 410 and the method returns. If service is available at decision block 408, then a request for service can be made at step 412 and a challenge and response can optionally be made at step 414. . If the response fails to meet the challenge at decision block 416, then the devices disconnect at step 410 and return. If the response meets the challenge at decision block 416, then the mobile or telematic device can provide a profile including particular thresholds to be monitored by the telematics device at step 418. The owner of such a service (e.g., the driver or a parent monitoring their child via the mobile device) can also be notified of the profile information at step 420 and the monitoring begins at decision block 422. If the threshold is not exceeded, then the service connection can be monitored at step 423. If the service is still available and the threshold is not exceeded, then the monitoring continues at block 422. If the threshold is not exceeded and no service is detected at step 423, then the method returns to the beginning of the process to step 402. If a threshold (speed, acceleration, deceleration, braking, etc.) is exceeded, a message can be created at step 424 and sent via the child's mobile device to a parent or guardian at step 426. The message sent can be a simple alert message or be as complex as a multimedia message having location information including the parameters exceeded as well as other parameters. Optionally, the method can further include the step 428 of informing the driver or owner of the service that a message has been sent to a parent or guardian regarding the threshold exceeding event. This can possibly serve as a deterrent for further inappropriate behavior.

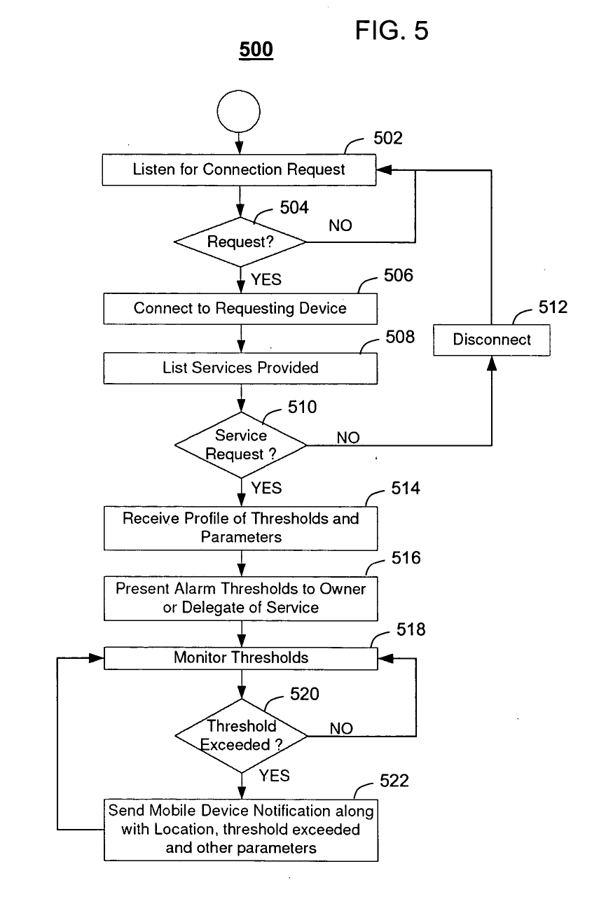

Referring to FIG. 5, a flow chart of a method 500 of monitoring personal safety of a third party in a vehicle and more particularly of a telematics unit in communication with a mobile device during service discovery and acquisition. At step 502, the telematics unit can listen for a connection request from a mobile unit. If a no request is found at decision block 504, the telematics unit continues to listen at step 502. If a request is found at decision block 504, then a connection is made to the requesting device at step 506 and a list of services is provided to the requesting (mobile) device at step 508. If no service is requested at decision block 510, then the devices disconnect at step 512 and the telematics device returns to listening for a connection request. If a service is requested at decision block 510, then the telematics device receives a profile including thresholds and parameters at step 514. The profile including the thresholds for monitoring can be presented at step 516 to the owner (or delegate) of the service (e.g., the driver). The thresholds are then monitored at step 518. If no threshold is exceeded at decision block 520, then the telematics device continues monitoring at step 518. If a threshold is exceeded at decision block 520, a message is generated at sent to the mobile device at step 522 for subsequent transmission via a wide area communication link to a parent or guardian.

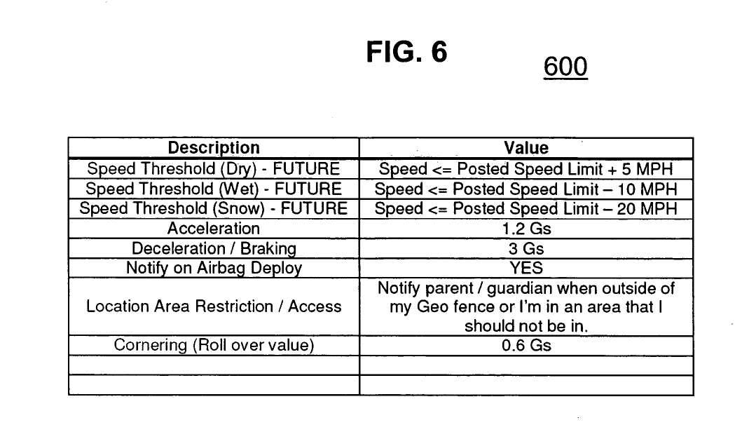

Referring to FIG. 6, an example of a profile 600 is illustrated that can be used for monitoring in a telematics application. As noted with respect to beacon signs 130 and 140, road signs in the future may communicate with a driver of the vehicle as to what speed limit is safe for the driving conditions of the road. The telematics reporting device can utilize the speed for the given road condition as one of the inputs (“posted speed limit”) to the profile 600 to determine if the driver is going too fast. If the speed is exceeded using the updated posted speed limit, then the passenger's mobile device can receive the notification from the telematics unit.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A wireless communication device, comprising:
a first wireless transceiver for communication over a wide area network;
a second wireless transceiver for communication over a short range; and
a processor coupled to the first wireless transceiver and the second wireless transceiver, wherein the processor is programmed to:
establish a communication link with a vehicle monitoring device using the second wireless transceiver; and
communicate a signal using the first wireless transceiver to a predetermined address.

2. The wireless communication device of claim 1, wherein the processor is further programmed to communicate the signal using the first wireless transceiver to the predetermined address if at least one predetermined threshold is exceeded by the vehicle monitoring device.

3. The wireless communication device of claim 1, wherein the vehicle monitoring device monitors at least one or more parameters among speed, location, acceleration, breaking distance, or airbag deployment.

4. The wireless communication device of claim 1, wherein the predetermined address is a guardian's home phone number, cellular phone number, dispatch private identifier, short messaging address, or email address.

5. The wireless communication device of claim 2, wherein the at least one predetermined threshold comprises among a speed limit, an acceleration, a deceleration, or an airbag deployment.

6. The wireless communication device of claim 1, wherein the processor can be further programmed to safely disable a vehicle remotely by receiving signals from the first wireless transceiver and relaying them to the second wireless transceiver.

7. The wireless communication device of claim 1, wherein the wireless communication device comprises a satellite position system receiver coupled to the processor.

8. The wireless communication device of claim 1, wherein the second wireless transceiver uses at least one among an Open Services Gateway framework, Simple Object Access Protocol, or Bluetooth to communicate over a short range with the vehicle monitoring device.

9. The wireless communication device of claim 2, wherein the processor is further programmed to determine the at least one predetermined threshold by receiving an external signal from a traffic authority and computing a threshold from the external signal.

10. A personal safety monitoring system, comprising:
a safety monitoring device for monitoring operational safety parameters of a vehicle, the safety monitoring box further operatively coupled to a first short range transceiver;
a wide area network wireless transceiver for communication over a wide area network;
a second short range transceiver operatively coupled to the wide area network wireless transceiver; and
a processor coupled to the wide area network wireless transceiver and the second short range transceiver, wherein the processor is programmed to:
establish a communication link with the safety monitoring device using the second short range transceiver; and
communicate a signal using the wide area network wireless transceiver to a predetermined address.

11. The personal safety monitoring system of claim 10, wherein the processor is further programmed to communicate the signal using the wide area network wireless transceiver to the predetermined address if at least one predetermined threshold is exceeded by the safety monitoring device.

12. The personal safety monitoring system of claim 10, wherein the wide area network wireless transceiver is a cellular wireless or a WLAN transceiver and the second wireless transceiver is a Bluetooth transceiver.

13. The personal safety monitoring system of claim 10, wherein the safety monitoring device monitors at least one or more parameters among speed, location, acceleration, breaking distance, or airbag deployment.

14. The personal safety monitoring system of claim 10, wherein the predetermined address is a guardian's home phone number, cellular phone number, dispatch private identifier, short messaging address, or email address.

15. The personal safety monitoring system of claim 11, wherein the at least one predetermined threshold comprises among a speed limit, an acceleration, a deceleration, or an airbag deployment wherein the at least one predetermine threshold can be pre-stored in the safety monitoring device or transmitted over the air to the safety monitoring device from the second short range transceiver to the first short range transceiver.

16. The personal safety monitoring system of claim 11, wherein the processor is further programmed to determine the at least one predetermined threshold by receiving an external signal from a traffic authority and computing a threshold from the external signal.

17. A method of monitoring personal safety of a third party in a vehicle, comprising the steps of:
establishing a communication link between a wide area wireless transceiver and a short range wireless transceiver;
monitoring a predetermined list of parameters and corresponding thresholds related to safe vehicle operation;
reporting information regarding any excesses beyond the corresponding thresholds to the wide area wireless transceiver via the short range wireless transceiver; and
relaying the information from the short range wireless transceiver to a predetermined address using the wide area wireless transceiver.

18. The method of claim 17, wherein the step of monitoring comprising the step of monitoring at least one or more parameters among speed, location, acceleration, breaking distance, or airbag deployment.

19. The method of claim 17, wherein the step of relaying comprises the step of relaying to a predetermined address among a guardian's home phone number, cellular phone number, dispatch private identifier, short messaging address, or email address.

20. The method of claim 17, wherein the method further comprises the step of determining the at least one predetermined threshold by receiving an external signal from a traffic authority and computing a threshold from the external signal.
